(19) United States
(12) Patent Application Publication
(10) Pub. No.: US 2012/0202097 A1
(43) Pub. Date: Aug. 9, 2012

(54) LITHIUM ION SECONDARY CELL

(76) Inventors: Naoki Kimura, Hitachi-shi (JP); Takenori Ishizu, Hitachinaka-shi (JP)

(21) Appl. No.: 13/394,909

(22) PCT Filed: Aug. 11, 2010
(86) PCT No.: PCT/JP2010/063649

§ 371 Date: Apr. 24, 2012

(30) Foreign Application Priority Data
Sep. 28, 2009 (JP) 2009-223152

(51) Int. Cl. H01M 10/04; H01M 10/02; H01M 2/02

(52) U.S. Cl. 429/94

(57) ABSTRACT

In a lithium ion secondary cell including a wound group 20 in which a positive electrode 24 including a positive electrode mixture layer 5 and a negative electrode 22 including a negative electrode mixture layer 6 are wound with the interposition of separators 21, 23, a winding starting edge 22S is disposed more towards an inner peripheral side than the positive electrode 24; a winding ending edge 22E is disposed more towards an outer peripheral side than a winding ending edge 24E; the winding starting edges 24S, 22S, and the winding ending edges 24S, 22E are disposed within a flat portion of the wound group 20; and the negative electrode mixture layer 6 covering a surface of the positive electrode mixture layer 5 is disposed on an inner and an outer circumferential surface of the positive electrode mixture layer 5.

### TECHNICAL FIELD

The present invention relates to a construction for a wound group of a lithium ion secondary cell.

### BACKGROUND ART

A lithium ion secondary cell that is mounted to a hybrid automobile or to an electric automobile includes a wound group that consists of a positive electrode, a negative electrode, and separators and that serves as an electricity generation element, and this wound group is immersed in an electrolyte. In addition to retaining the electrolyte, the separators are for preventing short circuiting due to contacting between the positive electrode and the negative electrode.

With such a lithium ion secondary cell, it is known that internal short circuiting can be caused by piercing of the separators due to deposition of lithium dendrites upon the negative electrode, and by the separators being pierced by the end portions of the positive electrode and the negative electrode. Thus, in the non-aqueous electrolyte secondary cell of Patent Document #1, an inorganic substance is painted upon the surfaces of the electrodes and the separators, and this prevents internal short circuiting.

### CITATION LIST

### Patent Literature

Patent Document #1: Japanese Laid-Open Patent Publication 2008-210573.

### SUMMARY OF THE INVENTION

### Technical Problem

With the secondary cell of Patent Document #1, there are problems of reduction of the performance of the cell, and of increase in the base cost of manufacture.

### Solution To The Problem

According to the 1st aspect of the present invention, a lithium ion secondary cell, comprises: a wound group, in which a sheet shaped positive electrode comprising a positive electrode mixture layer and a sheet shaped negative electrode comprising a negative electrode mixture layer are wound together with the interposition of a separator, and that is formed into a flattened shape configured to include a flat portion and circular arc shaped portions joined at opposite edges of the flat portion; and a cell casing in which the wound group is accommodated in a state of being immersed in an electrolyte, and that includes an external positive terminal that is connected to the sheet shaped positive electrode and an exterior negative terminal that is connected to the sheet shaped negative electrode; and wherein: a winding starting edge of the negative electrode is disposed more towards an inner peripheral side of the wound group than a winding starting edge of the positive electrode; a winding ending edge of the negative electrode is disposed more towards an outer peripheral side of the wound group than a winding ending edge of the positive electrode; the winding starting edge of the positive electrode, the winding starting edge of the negative electrode, the winding ending edge of the positive electrode, and the winding ending edge of the negative electrode are disposed within a region of the flat portion of the wound group not so as to be disposed within a region of the circular arc portions of the wound group; and the negative electrode mixture layer entirely covering a surface of the positive electrode mixture layer is disposed on an inner circumferential surface and an outer circumferential surface of the positive electrode mixture layer.

According to the 2nd aspect of the present invention, it is preferred that in the lithium ion secondary cell according to the 1st aspect, the winding starting edge of the positive electrode and the winding ending edge of the positive electrode are disposed so as not to be mutually overlapped in a direction from a front to a back of the flat portion, and the winding starting edge of the negative electrode and the winding ending edge of the negative electrode are disposed so as not to be mutually overlapped in the direction from the front to the back of the flat portion.

According to the 3rd aspect of the present invention, it is preferred that in the lithium ion secondary cell according to the 1st or the 2nd aspect, the flat portion of the wound group has an upper half flat portion and a lower half flat portion separated by a boundary at a central axis in a thickness direction; the winding starting edge of the positive electrode and the winding starting edge of the negative electrode are disposed at the inner peripheral side of one of the upper half flat portion and the lower half flat portion; and the winding ending edge of the positive electrode and the winding ending edge of the negative electrode are disposed at the outer peripheral side of the one of the upper half flat portion and the lower half flat portion at which the winding starting edge of the positive and the winding starting edge of the negative electrode are disposed.

According to the 4th aspect of the present invention, it is preferred that in the lithium ion secondary cell according to any one of the 1st through 3rd aspects, a winding start side portion of the positive electrode at an innermost turn of the wound group is disposed so as not to overlap a winding end side portion of the negative electrode at an outermost turn, and a winding start side portion of the negative electrode at the innermost turn of the wound group is disposed so as not to overlap a winding side end portion of the negative electrode at the outermost turn.

According to the 5th aspect of the present invention, it is preferred that in the lithium ion secondary cell according to any one of the 1st through 4th aspects, a winding start side portion of the positive electrode at an innermost turn of the wound group is disposed so as not to overlap a winding end side portion of the positive electrode at an outermost turn and a winding end side portion of the negative electrode at the outermost turn, and a winding start side portion of the negative electrode at the innermost turn of the wound group is disposed so as not to overlap the winding end side portion of the positive electrode at the outermost turn and the winding end side portion of the negative electrode at the outermost turn.

According to the 6th aspect of the present invention, a lithium ion secondary cell comprises: a wound group formed by winding a layered sheet to assume a substantially circular arcuate shape while the layered sheet is repeatedly turned back at each opposite end of the circular arcuate shape and in which two upper and lower outer surfaces and two inner surfaces facing the two outer surfaces are flat surfaces at a central portion, the layered sheet being constituted by laminating a sheet shaped positive electrode in which a positive electrode mixture layer provided from a winding starting edge to a winding ending edge is spread on both sides of a metallic collector, a sheet shaped negative electrode in which a negative electrode mixture layer provided from the winding starting edge to the winding ending edge is spread on both sides of a metallic collector, and a sheet shaped separator is interposed between the positive electrode and the negative electrode, wherein: the winding starting edge of the negative electrode is disposed more to an inner peripheral side of the wound group than the winding starting edge of the positive electrode; the winding ending edge of the negative electrode is disposed more to an outer peripheral side of the wound group than the winding ending edge of the positive electrode; the winding starting edge of the positive electrode, the winding starting edge of the negative electrode, the winding ending edge of the positive electrode, and the winding ending edge of the negative electrode are disposed at positions that correspond to the flat surface; and the winding starting edge of the negative electrode is disposed more towards the winding center of the wound group than the winding starting edge of the positive electrode.

According to the 7th aspect of the present invention, it is preferred that in the lithium ion secondary cell according to the 6th aspect, the negative electrode mixture layer entirely covering a surface of the positive electrode mixture layer is disposed on an inner circumferential surface and an outer circumferential surface of the positive electrode mixture layer.

According to the 8th aspect of the present invention, it is preferred that in the lithium ion secondary cell according to the 6th or 7th aspect, the winding starting edge of the positive electrode and the winding ending edge of the positive electrode are disposed so as not mutually to overlap in a direction from a front to a back of the central portion, and the winding starting edge of the negative electrode and the winding ending edge of the negative electrode are disposed so as not mutually to overlap in the direction from the front to the back of the central portion.

According to the 9th aspect of the present invention, it is preferred that in the lithium ion secondary cell according to any one of the 6th through 8th aspects, the winding starting edge of the positive electrode, the winding starting edge of the negative electrode, the winding ending edge of the positive electrode, and the winding ending edge of the negative electrode are disposed upon one of the inner surfaces of the central portion of the wound group, and upon the outer surface that opposes that one of the inner surfaces.

According to the 10th aspect of the present invention, it is preferred that in the lithium ion secondary cell according to any one of the 6th through the 9th aspects, a winding start side portion of the positive electrode at an innermost turn of the wound group is disposed so as not to overlap a winding end side portion of the negative electrode at an outermost turn thereof, and a winding start side portion of the negative electrode at the innermost turn of the wound group is disposed so as not to overlap a winding end side portion of the negative electrode at the outermost turn thereof.

According to the 11th aspect of the present invention, it is preferred that in the lithium ion secondary cell according to any one of the 6th through 10th aspects, a winding start side portion of the positive electrode at an innermost turn of the wound group is disposed so as not to overlap a winding end side portion of the positive electrode at an outermost turn thereof and a winding end side portion of the negative electrode at the outermost turn thereof, and a winding start side portion of the negative electrode at an innermost turn of the wound group is disposed so as not to overlap the winding end side portion of the positive electrode at the outermost turn thereof and the winding end side portion of the negative electrode at the outermost turn thereof.

### Advantageous Effect of the Invention

According to the lithium ion secondary cell of the present invention, the deposition of lithium dendrites upon the negative electrode of the wound group that is an electricity generation element is suppressed, and accordingly it is possible to enhance the reliability of the lithium ion secondary cell.

### BRIEF DESCRIPTION OF THE DRAWINGS

FIG. 1 is a table giving specifications of the positive electrode and the negative electrode of Embodiments #1 through #4 of the lithium ion secondary cell of the present invention, and of Comparison Examples #1 through #8;

FIG. 2 is a table for comparison of the specifications of the wound groups of Embodiments #1 through #4, and of Comparison Examples #1 through #8;

FIG. 3 is a table for comparison of the amounts of voltage decrease in Embodiments #1 through #4 and in Comparison Examples #1 through #8;

FIG. 4 is a table giving specifications of the positive electrode and the negative electrode of Embodiments #5 and #6 of the lithium ion secondary cell of the present invention, and of Comparison Examples #9 through #14;

FIG. 5 is a table for comparison of the specifications of the wound groups of Embodiments #5 and #6 and of Comparison Examples #9 through #14;

FIG. 6 is a table for comparison of the capacity maintenance ratios of Embodiments #5 and #6 and of Comparison Examples #9 through #14;

FIG. 7 is a table giving specifications of the positive electrode and the negative electrode of Embodiments #7 and #8 of the lithium ion secondary cell of the present invention;

FIG. 8 is a table showing the winding start and winding end positions of the positive electrode and the negative electrode of Embodiments #7 and #8;

FIG. 9 is an exploded perspective view showing a lithium ion secondary cell according to the present invention;

FIG. 10(a) is a figure for explanation of sheet layer, and FIG. 10(b) is a side sectional view showing a wound group of the lithium ion secondary cell of FIG. 9;

FIG. 11 is a partially exploded perspective view showing this wound group;

FIG. 12 is a perspective view showing the dimensions of this wound group;

FIG. 13 is a perspective view showing the positions of the winding starts and the winding ends of this wound group; and

FIG. 14 is a sectional view of this wound group, showing the positions of the winding start and the winding end of its anode.

### DESCRIPTION OF THE EMBODIMENTS

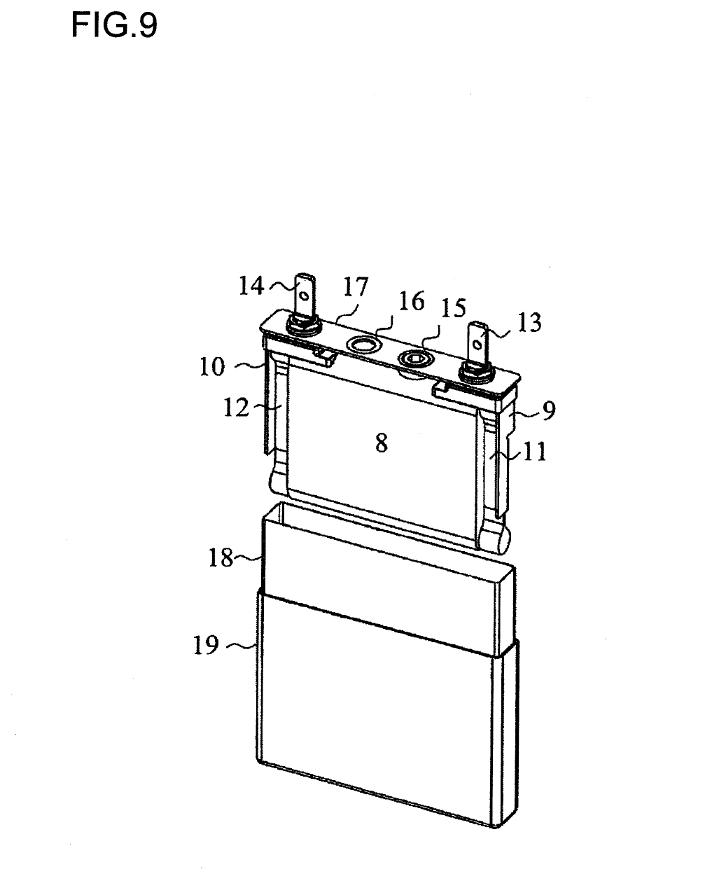

Referring to FIGS. 9 through 12, the structure of a lithium ion secondary cell according to an embodiment of the present invention will be explained. The lithium ion secondary cells of Embodiments #1 through #8 and of Comparison Examples #1 through #14 are all examples of the lithium ion secondary cell as shown in FIGS. 9 through 12, except for the detailed structures of their wound groups. It should be understood that the lithium ion secondary cell that is the subject of this specification may, for example, be a cell of 5 Ah rating, and its capacity ratio (negative electrode capacity/positive electrode capacity) may, for example, be 1.0 to 1.2.

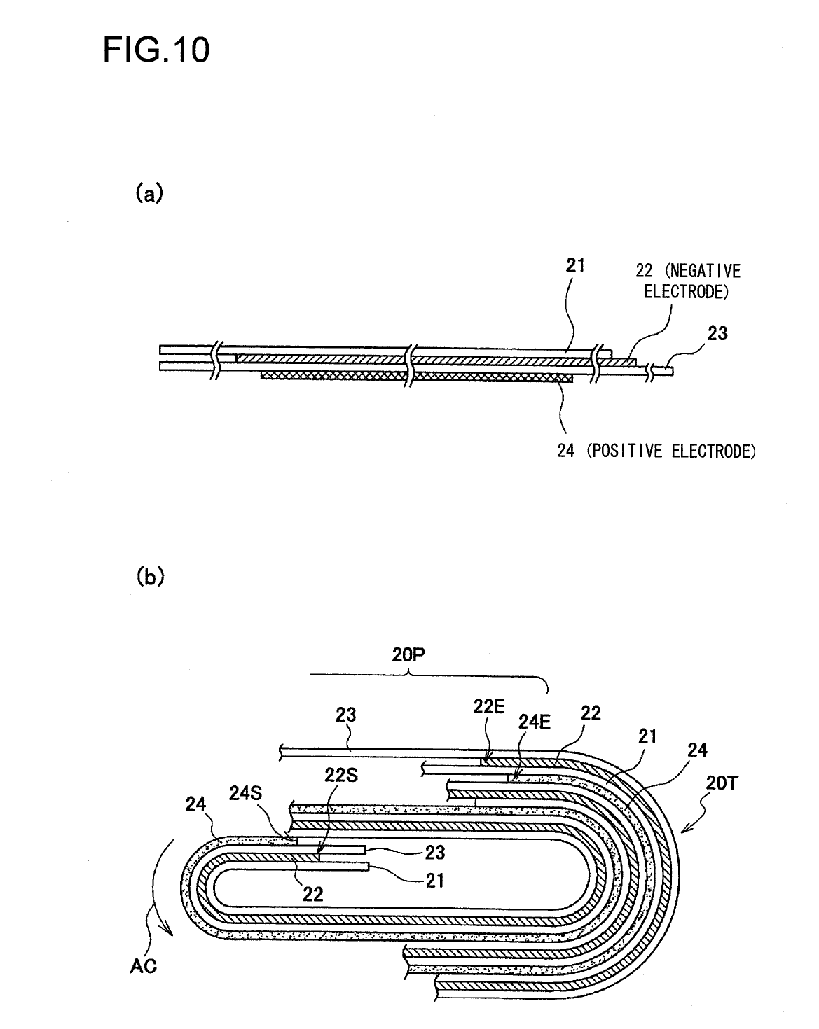

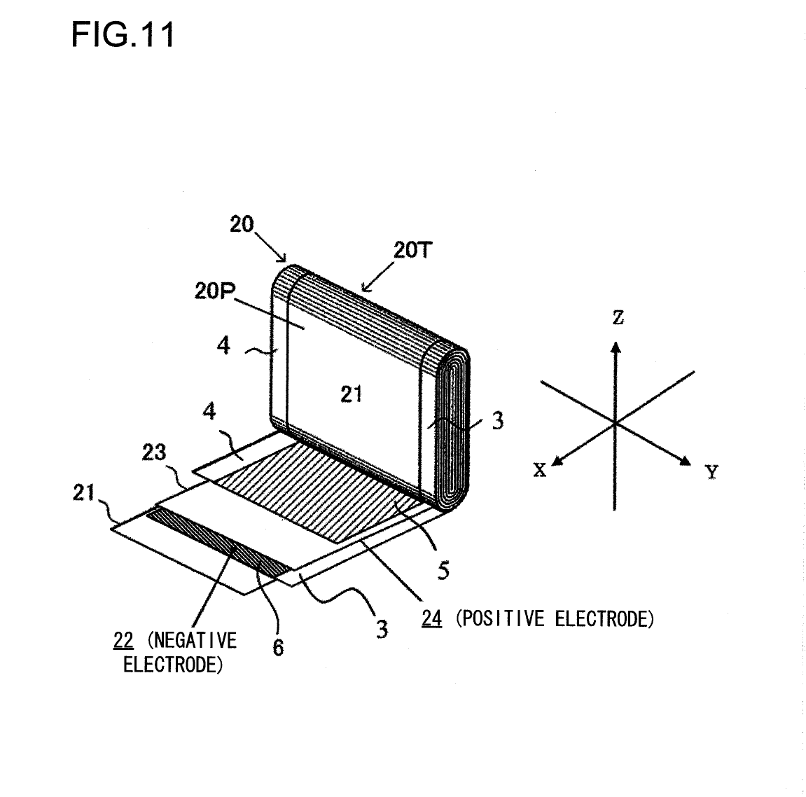

This lithium ion secondary cell consists of a wound group 20 shown in FIG. 11 that is an electricity generation element, is covered with an insulating cover 18 and is accommodated within a cell casing 19 as shown in FIG. 9. As shown in FIG. 10(a), this wound group 20 is made by laminating together a separator 21 shaped as a sheet, a negative electrode 22 shaped as a sheet, a separator 23 shaped as a sheet, and a positive electrode 24 shaped as a sheet in this specified order. As shown in FIG. 10(a), the negative electrode 22 is longer than the positive electrode 24 and sticks out further. As shown in FIG. 10(b), this wound group 20 has a flattened shape in which a flat portion is formed by a central portion whose cross section is a flat rectangle, and a circular arc shaped portions whose cross sections are semicircular are formed at both the ends of this central portion. In this case, both of the circular arc shaped portions have shapes that are bilaterally symmetric with respect to the flat portion.

The winding starting edge 22S of the negative electrode 22 is positioned at the innermost circumferential portion of the wound group 20. And the winding ending edge 22E of the negative electrode 22 is positioned at the outermost circumferential portion of the wound group 20. Moreover, as shown in FIG. 10(b), the winding starting edge 22S of the negative electrode 22 is positioned more to the interior than the winding starting edge 24S of the positive electrode 24, and the winding ending edge 22E of the negative electrode 22 is positioned more to the exterior than the winding ending edge 24E of the positive electrode 24. Due to this, the negative electrode 22 completely covers the entire positive electrode 24.

It should be understood that separators 21 and 23 that are shaped as sheets are interposed between the positive electrode 24 and the negative electrode 22, and the sheet shaped separator 23 that is disposed upon the outwardly facing circumferential surface of the negative electrode 22 serves as the outer circumferential surface of the wound group 20.

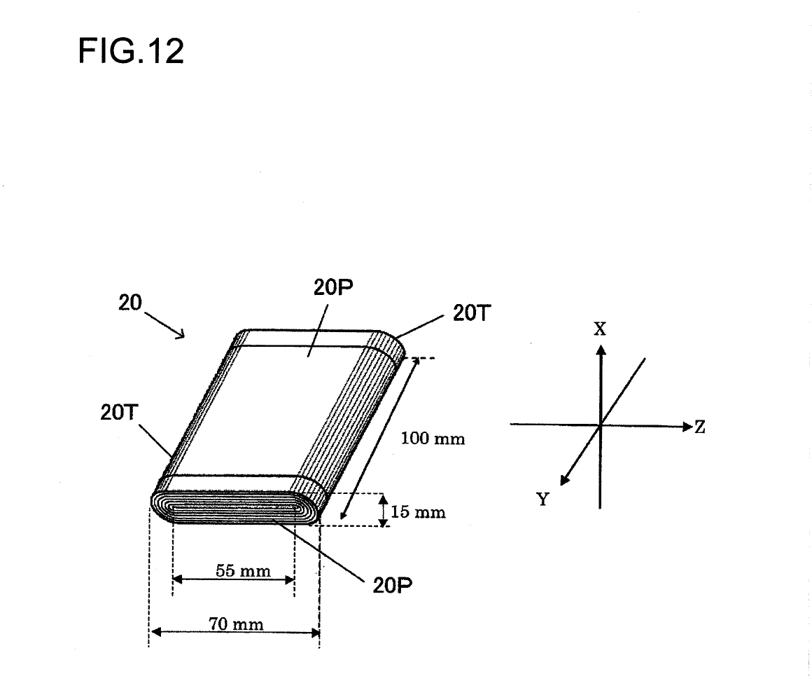

FIG. 11 is an external perspective view for explaining the details of this wound group 20, and FIG. 12 is an external perspective view showing the wound group 20 in its completed state. As described above, the wound group 20 is formed with circular arc shaped portions whose outer circumferential surfaces are shaped as circular arcuate surfaces 20T and the flat portion whose outer circumferential surfaces are flat surfaces 20P being linked together.

The details of this wound group 20 will now be explained with reference to FIG. 11.

The positive electrode 24 is a sheet provided in the shape of a mat, in which a metallic collector, for example a sheet of aluminum foil, is covered on both its sides with a positive electrode mixture layer 5 from its winding starting edge 24S to its winding ending edge 24E. An unapplied positive electrode portion 4 to which the positive electrode mixture layer 5 is not applied is defined at one end edge portion of the aluminum foil, and this is used as a positive current collection portion. And the negative electrode 22 is a sheet provided in the shape of a mat, in which a metallic collector, for example a sheet of copper foil, is covered on both its sides with a negative electrode mixture layer 6 from its winding starting edge 22S to its winding ending edge 22E. An unapplied negative electrode portion 3 to which the negative electrode mixture layer 6 is not applied is defined at one end edge portion of the copper foil, and this is used as a negative current collection portion. The unapplied positive electrode portion 4 to which the positive electrode mixture layer 5 is not applied and the unapplied negative electrode portion 3 to which the negative electrode mixture layer 6 is not applied are disposed on opposite sides of their sheets with respect to their centers in the longitudinal direction.

Referring now to FIG. 9, a junction portion 11 of a positive current collection lead portion 9 that is made from aluminum is connected to the unapplied positive electrode portion 4 of the wound group 20 by ultrasonic welding, and a junction portion 12 of a negative current collection lead portion 10 that is made from copper is connected to the unapplied negative electrode portion 3 by ultrasonic welding. These collector lead portions 9 and 10 are respectively connected to a positive terminal 13 and to a negative terminal 14 that are installed to a lid 17 of this cell, and due to this, along with the wound group 20 being supported by the cell lid 17, it also becomes possible to perform charging and discharging thereof via the positive terminal 13 and the negative terminal 14.

An electrolyte filling aperture 15 is provided to the cell lid 17 for injecting an electrolyte (for example 1MLiPF₆/EC:EMC=1:3), and moreover a gas rupture valve 16 is provided for venting the internal pressure when it exceeds some standard reference value. The electrolyte filling aperture 15 is blocked by laser welding after injection of the electrolyte. And the cell casing 19 is sealed by the cell lid 17 being welded to the cell casing 19 by laser welding.

### The Lithium Ion Secondary Cells of the First Through the Fourth Embodiments

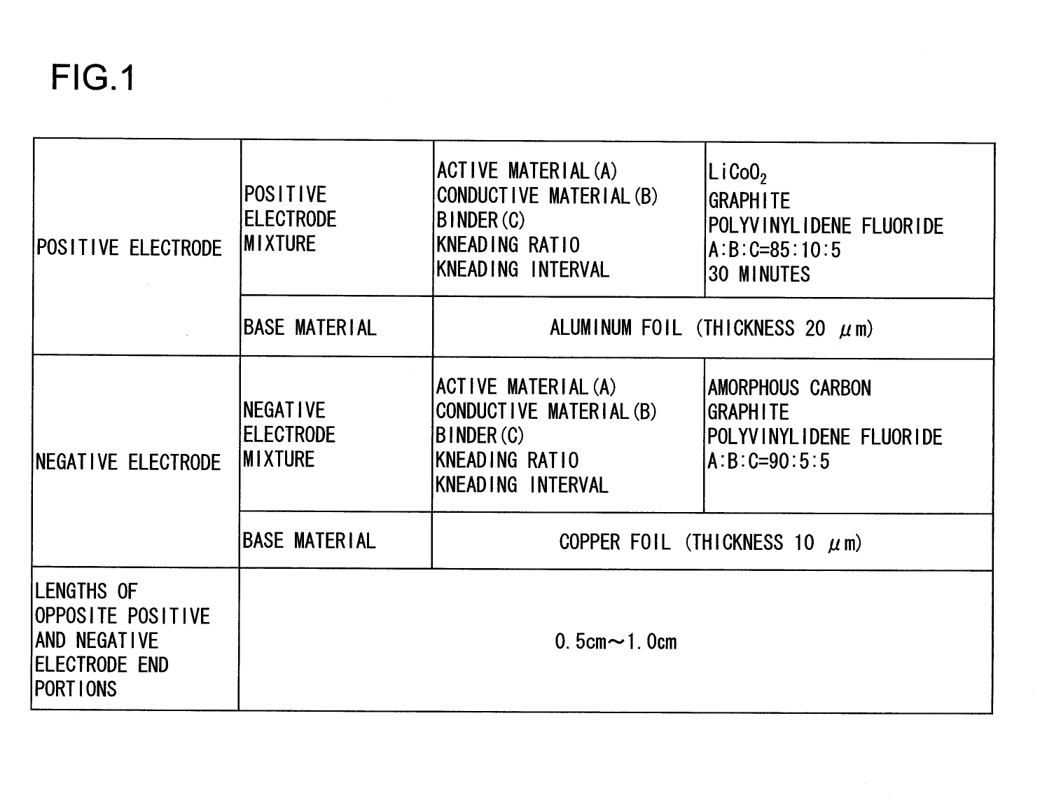

As shown in FIG. 1, the positive electrode mixture layers in the wound groups 20 of Embodiments #1 through #4 and of Comparison Examples #1 through #8 employed LiCoO₂ as the positive electrode active material, and they were manufactured in the following manner.

That is to say, a kneading machine was used upon a mixture of the positive electrode active material, graphite as a conductive material, and polyvinylidene fluoride as a binder at weight proportions of 85:10:5, and the positive electrode mixture was obtained after kneading for 30 minutes. This positive electrode mixture was applied on both sides of sheets of aluminum foil (i.e. of the base material) at a thickness of 20 μm.

On the other hand, using amorphous carbon for the negative electrode active material of the negative electrode mixture layer, and using graphite as a conductive material and polyvinylidene fluoride as a binder, negative electrode active material:conductive material:binder were kneaded together in the weight proportions of 90:5:5. The negative electrode mixture that was thus obtained was applied on both sides of sheets of copper foil at a thickness of 10 μm.

Then, after having formed both the positive electrode 24 and the negative electrode 22 that were thus manufactured into rolled form with a pressing machine, vacuum drying was performed at 100° C. for a period of 24 hours. And, after drying, the positive electrode 24 and the negative electrode 22 were laid over one another with the interposition of the separators 21 and 23, and the wound groups 20 were manufactured by changing the positions of the winding starting edge 24S and the winding ending edge 24E of the positive electrode 24 and of the winding starting edge 22S and the positions of the winding ending edge 22E of the negative electrode 22 for each of the embodiments and the comparison examples. No axial cores were used for the winding groups 20, but it was arranged to wind the separators around four times, so as to position the winding starting edge 22S of the negative electrode 22 at the innermost turn of the wound group 20, and so as to position the winding ending edge 22E of the negative electrode 22 at the outermost turn of the wound group 20. Moreover the winding starting edge 22S of the negative electrode 22 was wound so as to be 0.5 cm to 1.0 cm longer than the winding starting edge 24S of the positive electrode 24, and similarly the winding ending edge 22E of the negative electrode 22 was wound so as to be 0.5 cm to 1.0 cm longer than the winding ending edge 24E of the positive electrode 24.

As shown in FIG. 12, the overall size of this wound group 20 is 70 mm (length) by 100 mm (width in the axial direction) by 15 mm (thickness). The diameters of the circular arcuate surfaces 20T on the outermost turns of the circular arc shaped portions of the wound group 20 were made to be 15 mm, while the flat portion was made to be 55 mm (length) by 100 mm (width in the axial direction).

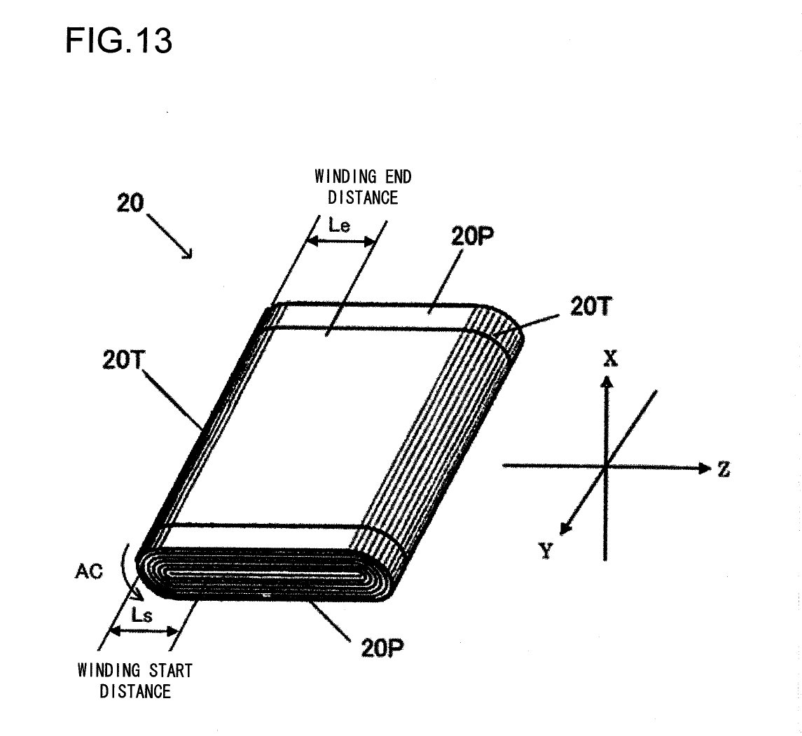

As shown in FIGS. 12 and 13, the winding start distance Ls (refer to FIG. 13) from the final end of the wound group 20, to put it in another manner, from the circular arcuate surface 20T on the outermost turn of the circular arc shaped portion in the length direction of the wound group 20 (i.e. in the Z axis direction) to the winding starting edge 24 of the positive electrode 24 and the winding starting edge 22S of the negative electrode 22 was varied, and the winding was performed in the winding direction AC as seen in FIG. 10(b). And, at this time, the winding end distance Le from the final end 20 of the wound group 20 to the winding ending edge 24E of the positive electrode 24 and to the winding ending edge 22E of the negative electrode 22 (refer to FIG. 13) was also varied.

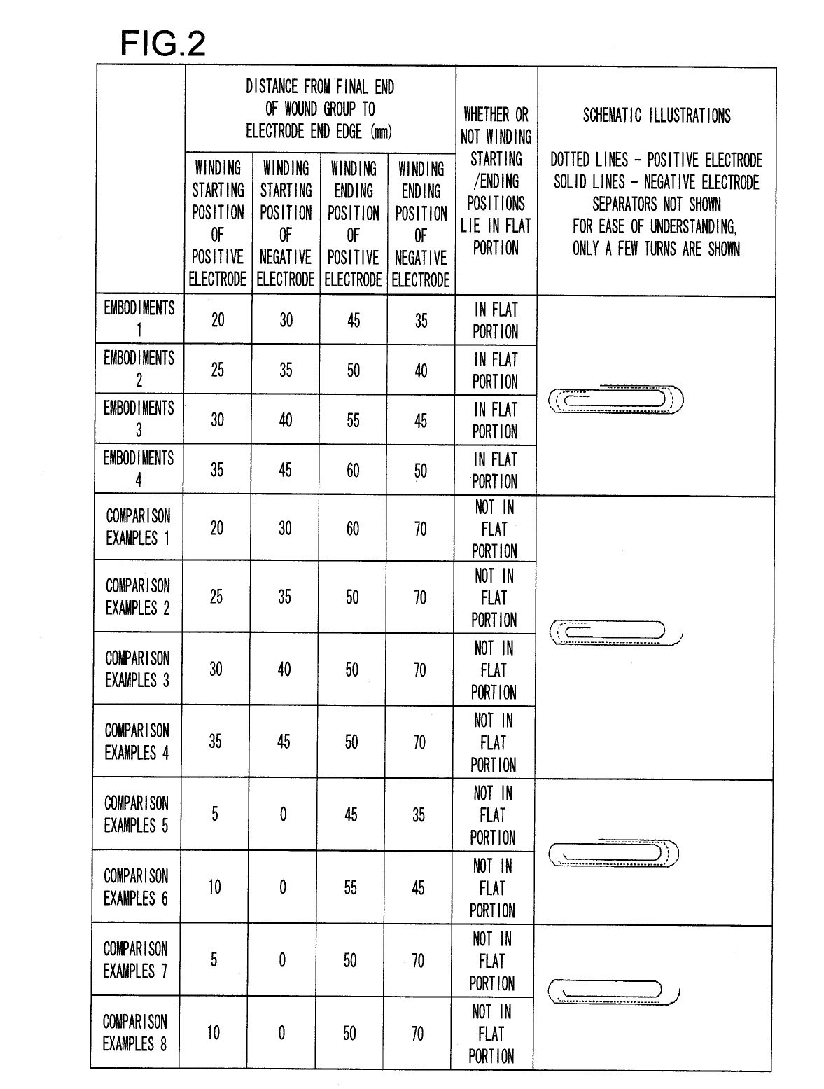

As shown in FIG. 2, and in particular as shown in the fields thereof which present schematic illustrations, in Embodiment #1 through Embodiment #4, the overlapped layers of the separator 21, the negative electrode 22, the separator 23, and the positive electrode 24 of FIG. 10(a) were wound up so that all of the end portions of these sheets, i.e. the winding starting edge 24S and the winding ending edge 24E of the positive electrode 24 and the winding starting edge 22S and the winding ending edge 22E of the negative electrode 22, were positioned within a region of flat surfaces 20P.

On the other hand, in Comparison Examples #1 through #8, as shown in FIG. 2, similar overlapped sheets to those of FIG. 10(a) were wound up so that one of the end portions of these sheets, i.e. the winding starting edge 24S and the winding ending edge 24E of the positive electrode 24 and the winding starting edge 22S and the winding ending edge 22E of the negative electrode 22, or all of these end portions, were not positioned within any region of the flat surface 20P, but rather were positioned within the circular arc shaped portions. In concrete terms, in Comparison Examples #1 through #4, as shown in the fields of FIG. 2 that present schematic illustrations, while the winding starting edge 24S of the positive electrode 24 and the winding starting edge 22S of the negative electrode 22 are positioned within the region of the flat surfaces 20P, the winding ending edge 24E of the positive electrode 24 and the winding ending edge 22E of the negative electrode 22 are not positioned within the region of the flat surfaces 20P, but were positioned within a region of the circular arcuate surfaces 20T. Moreover, in Comparison Examples #5 and #6, while the winding starting edge 24S of the positive electrode 24 and the winding starting edge 22S of the negative electrode 22 are not positioned within the region of the flat surfaces 20P, but are positioned within the region of the circular arcuate surfaces 20T, although the winding ending edge 24E of the positive electrode 24 and the winding ending edge 22E of the negative electrode 22 are positioned within the region of the flat surfaces 20P. And, in Comparison Examples #7 and #8, none of the winding starting edge 24S and the winding ending edge 24E of the positive electrode 24 and the winding starting edge 22S and the winding ending edge 22E of the negative electrode 22 are positioned within the region of the flat surfaces 20P, but rather all of them are positioned within the region of the circular arcuate surfaces 20T. In these cases, among the lengths of the positive electrode and the negative electrode, the negative electrode was the longer, as described above.

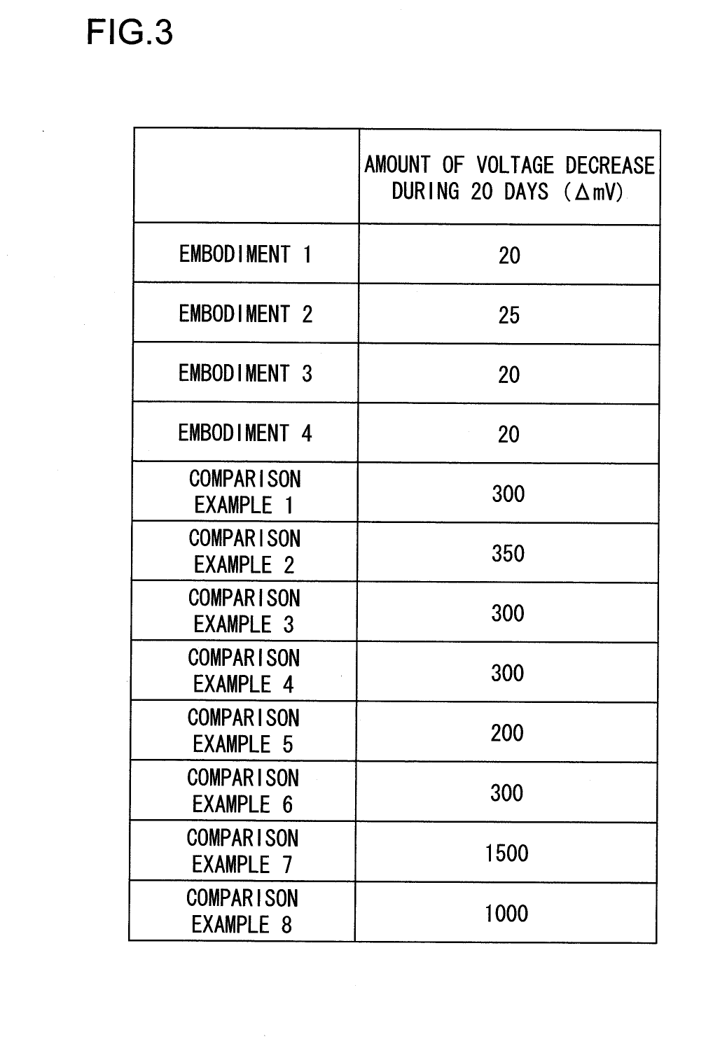

Charging and discharging of each of the lithium ion secondary cells of Embodiments #1 through #4 and of Comparison Examples #1 through #8 was performed through three cycles in which the final voltage after charging was completed was 4.1 V, the final voltage at the end of discharging was 2.7 V, and the charge and discharge rates were 1 C (i.e. at one hour rate of their nominal electrical capacity), and the cells were then charged up at a charging rate of 1 C to a final voltage at the end of charging of 3.7 V, and were stored for 20 days at 25° C., after which the decreases in their voltages were measured. The results of these tests are shown in FIG. 3.

From FIG. 3, it will be understood that the decreases in voltages in Embodiments #1 through #4 are small as compared to the decreases in voltages in Comparison Examples #1 through #8. In Comparison Examples #1 through #4 with which the positions of the winding ending edges 24E and 22E are not within the region of the flat surfaces 20P, the voltage drops are 300 to 350 mV. And in Comparison Examples #5 and #6 with which the positions of the winding starting edges 24S and 22S are not within the region of the flat surfaces 20P, the voltage drops are 200 to 300 mV.

Thus in both cases, i.e. both in Comparison Examples #1 through #4 with which the winding ending edges 24E and 22E are not positioned within the region of the flat surfaces 20P and also in Comparison Examples #5 and #6 with which the winding starting edges 24S and 22S are not positioned within the region of the flat surfaces 20P, voltage drops of around 300 mV are observed. Due to this it is considered that, when either the winding ending edges 24E and 22E or the winding starting edges 24S and 22S are positioned not within the region of the flat surfaces 20P, but rather within the region of the circular arcuate surfaces 20T, then lithium dendrites are deposited upon the end portions of the electrodes and internal short circuiting is taking place.

This fact is also verified by the fact that the voltage drops in the case of Comparison Examples #7 and #8 are remarkably large, at 1500 mV and 1000 mV. In other words while, in the cases of Examples #7 and #8 with which both the winding ending edges 24E and 22E and also the winding starting edges 24S and 22S are positioned not within the region of the flat surfaces 20P, but rather within the region of the circular arcuate surfaces 20T, it is presumed that this is due to deposition of lithium dendrites upon the electrodes at both their end portions.

Embodiments #1 through #4 are able to avoid this type of problem. In other words, since the deposition of lithium dendrites is kept low and internal short circuiting is suppressed by disposing the negative electrode 22 at both the innermost circumferential surface of the wound group 20 and also at its outermost circumferential surface, and moreover by disposing the winding starting edge 24S of the positive electrode 24 and the winding starting edge 22S of the negative electrode 22 and also the winding ending edge 24E of the positive electrode 24 and the winding ending edge 22E of the negative electrode 22 within the region of the flat surface 20P, accordingly it is possible to keep the voltage drop mV down to around 20 to 25 mV.

According to the lithium ion secondary cells of Embodiments #1 through #4, by internal short circuiting being prevented in this manner, there is no tendency towards reduction of performance or towards increase of cost, so that a lithium ion secondary cell is provided whose security and reliability are excellent.

### The Lithium Ion Secondary Cells of Embodiments #5 and #6

Lithium ion secondary cells of Embodiments #5 and #6 were manufactured in a similar manner to the lithium ion secondary cells of Embodiments #1 through #4, and these lithium ion secondary cells were compared with lithium ion secondary cells of Comparison Examples #9 through #14.

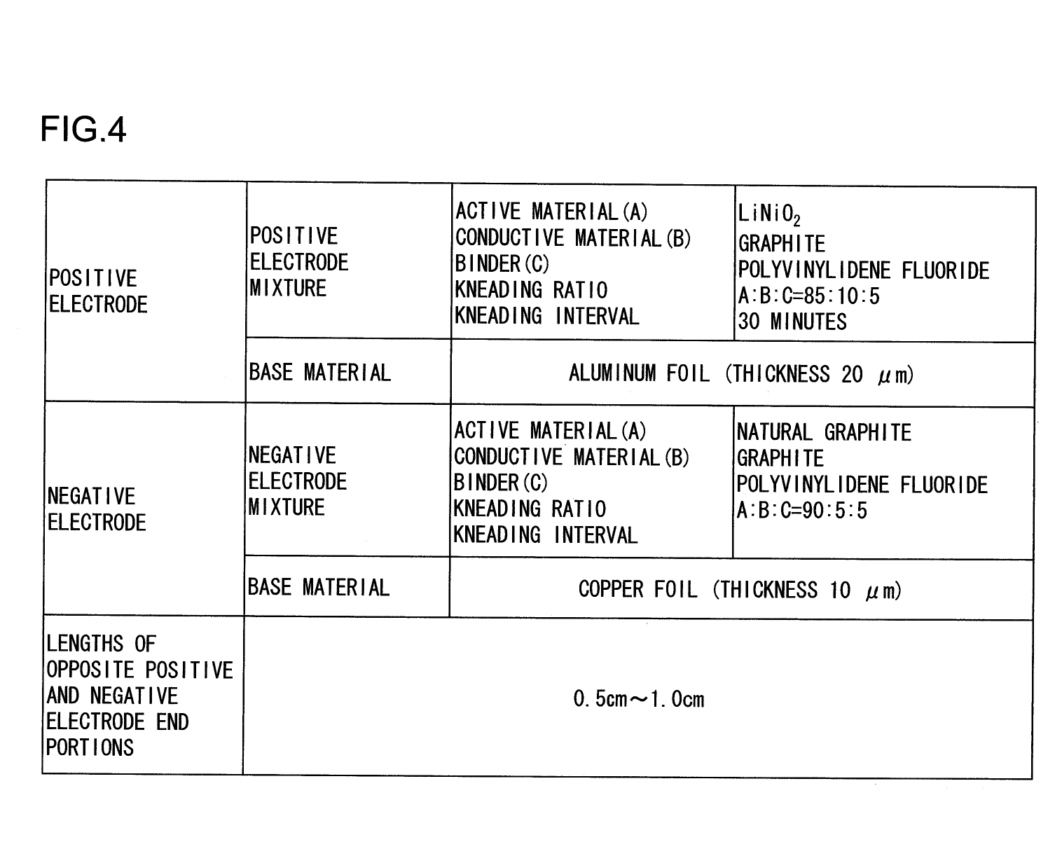

As shown in FIG. 4, in Embodiments #5 and #6 and in Comparison Examples #9 through #14, wound groups 20 were manufactured in a similar manner to those for the lithium ion secondary cells of Embodiments #1 through #4, but using LiNiO₂ as the positive electrode active material. It should be understood that the capacity ratios of these cells (negative electrode capacity/positive electrode capacity) were 1.0 to 1.2.

Moreover, it should be understood that the principal differences between the wound groups 20 of Embodiments #5 and #6, and the wound groups 20 of Embodiments #1 through #4, are that the former used LiNiO₂ as the positive electrode active material while the latter used LiCoO₂ as the positive electrode active material, and that the former used natural graphite as the negative electrode active material while the latter used graphite as the negative electrode active material.

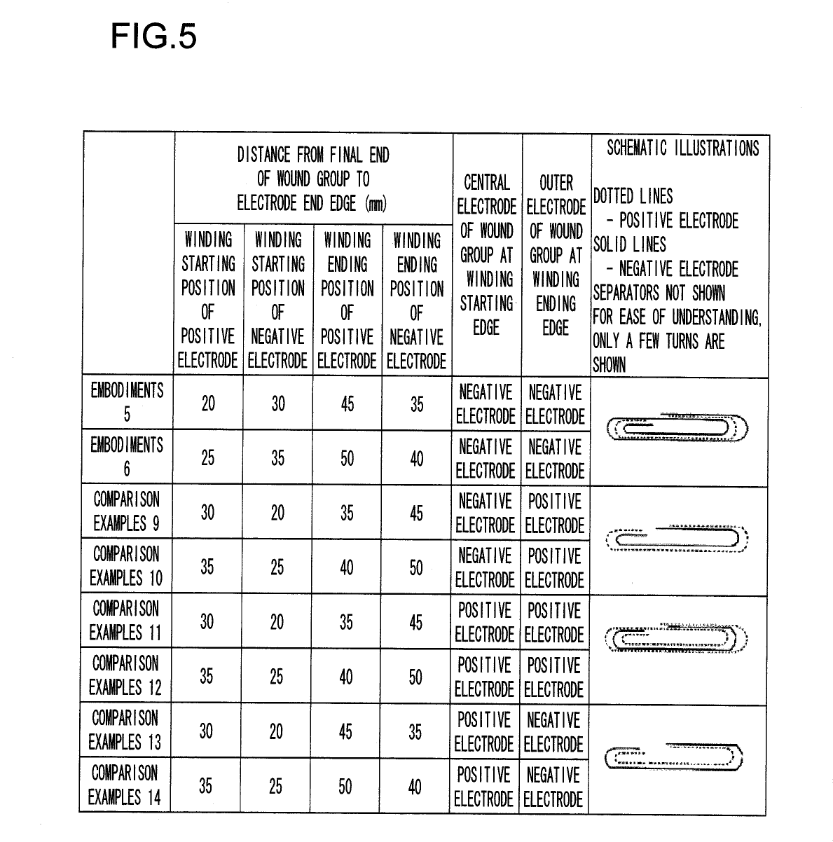

As shown in FIG. 5, in each of the wound groups 20 of Embodiments #5 and #6 and Comparison Examples #9 through #14, all of the winding ending edges 24E and 22E and the winding starting edges 24S and 22S are set at positions within the region of the flat surfaces 20P. The point of difference between the wound groups 20 of Embodiments #5 and #6 and Comparison Examples #9 through #14 is whether the polarity of the electrode that defines the winding starting edge at the innermost turn of the wound group 20 and the polarity of the electrode that defines the winding ending edge at the outermost turn of the wound group 20 are the positive electrode or is the negative electrode.

As shown in the fields of FIG. 5 that present schematic illustrations, the lithium ion secondary cells of Embodiment #5 and Embodiment #6 are wound so that the polarity of the sheet layer on the innermost turn that constituted the winding starting edge of the wound group 20, and also the polarity of the sheet layer on the outermost turn that constituted the winding ending edge of the wound group 20, both became the negative electrode. Moreover, the winding starting edge 22S of the negative electrode 22 of the wound group 20 is positioned more towards the center of the wound group 20 than the winding starting edge 24S of the positive electrode 24 of the wound group 20. And also the winding ending edge 22E of the negative electrode 22 of the wound group 20 is positioned more towards the center of the wound group 20 than the winding ending edge 24E of the positive electrode 24 of the wound group 20. To put this in another manner, both the end portions 22S and 22E of the negative electrode 22 are longer than the end portions 24S and 24E of the positive electrode 24, and moreover the structure is arranged so that both the innermost circumferential surface and also the outermost circumferential surface of the wound group 20 are covered by the negative electrode.

By contrast, the lithium ion secondary cells of Comparison Examples #9 through #14 are built as follows.

As shown in the fields of FIG. 5 that present schematic illustrations, in the lithium ion secondary cells of Comparison Examples #9 and #10, the winding starting edge 22S of the negative electrode 22 is disposed more towards the center of the wound group 20 than the winding starting edge 24S of the positive electrode 24, and also the winding ending edge 24E of the positive electrode 24 is disposed more toward the center of the wound group 20 than the winding ending edge 22E of the negative electrode 22. Furthermore, the polarity of the sheet layer on the innermost turn at the winding starting edge of the wound group 20 is the negative electrode. However, the polarity of the sheet layer on the outermost turn that constitutes the winding ending edge of the wound group 20 is the positive electrode.

Moreover, as shown in the fields of FIG. 5 that present schematic illustrations, in the lithium ion secondary cells of Comparison Examples #11 and #12, the winding starting edge 24S of the positive electrode 24 is disposed more towards the center of the wound group 20 than the winding starting edge 22S of the negative electrode 22, and also the winding ending edge 24E of the positive electrode 24 is disposed more toward the center of the wound group 20 than the winding ending edge 22E of the negative electrode 22. Furthermore the innermost turn at the winding starting edge of the wound group 20 is the positive electrode 24, and moreover the outermost turn that constituted the winding ending edge of the wound group 20 is also the positive electrode 24.

And, in the lithium ion secondary cells of Comparison Examples #13 and #14, the winding starting edge 24S of the positive electrode 24 is disposed more towards the center of the wound group 20 than the winding starting edge 22S of the negative electrode 22, while the winding ending edge 22E of the negative electrode 22 is disposed more toward the center of the wound group 20 than the winding ending edge 24E of the positive electrode 24. Furthermore the polarity of the sheet layer at the innermost turn at the winding starting edge of the wound group 20 is the positive electrode 24, and moreover the outermost turn that constituted the winding ending edge of the wound group 20 is the negative electrode 22.

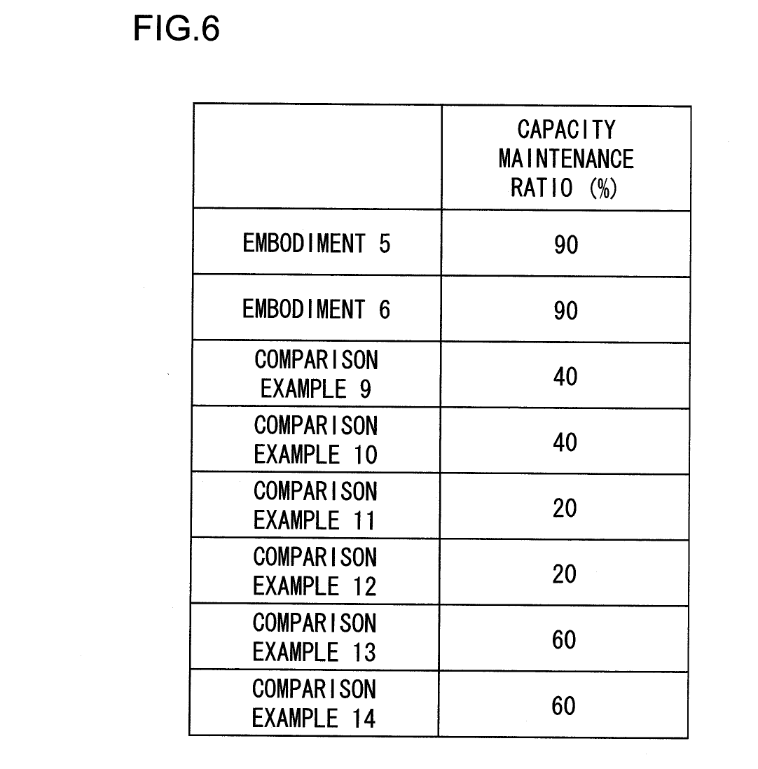

Charging and discharging of each of the lithium ion secondary cells of Embodiments #5 and #6 and of Comparison Examples #9 through #14 was performed through three cycles in which the final voltage after charging was completed was 4.1 V, the final voltage at the end of discharging was 2.7 V, and the charge and discharge rates were 1 C (i.e. at one hour rate of their nominal electrical capacity), and the cells were then charged and discharged at 60° C. through 1000 cycles in which the final voltage after charging was completed was 4.1 V, the final voltage at the end of discharging was 2.7 V, and the charge and discharge rates were 10 CA (i.e. at 1/10 hour rate of their nominal electrical capacity), and their capacity maintenance ratios were measured. The results of these tests are shown in FIG. 6.

It will be understood from FIG. 6 that the deterioration of capacity with the lithium ion secondary cells of Embodiments #5 and #6 is small as compared with the lithium ion secondary cells of Embodiments #9 through #14.

With the lithium ion secondary cells of Comparison Examples #9 through #14 after deterioration, since crystals that are silver-white in color are seen in the end portions of the negative electrode and a peak is observed in the neighborhood of 270 ppm as the result of solid ⁷Li-NMR (Nuclear Magnetic Resonance), the presence of lithium dendrites is clearly confirmed. On the other hand, this type of change was not observed in Embodiments #5 and #6.

This matter will now be inquired into further. With the lithium ion secondary cells of the Comparison Examples, at one or the other of the winding starting edge 24S or the winding ending edge 24E, the negative electrode is not present to oppose the positive electrode either at the surface adjacent to the positive electrode at the inner peripheral side or at the surface adjacent to the positive electrode at the outer peripheral side. It is presumed that due to this, occlusion and emission of the lithium become difficult and the lithium ions become localized at the end portion of the negative electrode that approaches the positive electrode, so that dendrites are deposited here due to excessive voltage. It is possible to avoid this situation with the lithium secondary cells of Embodiments #5.

In this manner, similar beneficial operational effects are obtained with the lithium ion secondary cells of Embodiments #5 and #6 as with those of Embodiments #1 through #4, even though only the positive electrode active material is different from that of Embodiments #1 through #4. In other words, it is possible to suppress the deposition of lithium dendrites by ensuring that the negative electrode 22 is present over a sufficient range at a position opposing the positive electrode 24 at both the winding starting edge and the winding ending edge, and by disposing the negative electrode mixture layer 4 over all of the positions that face the positive electrode mixture layer with the interposition of the separators 21 and 23, and thereby it is possible to enhance the performance of the lithium ion secondary cells.

### The Lithium Ion Secondary Cells of Embodiments #7 and #8

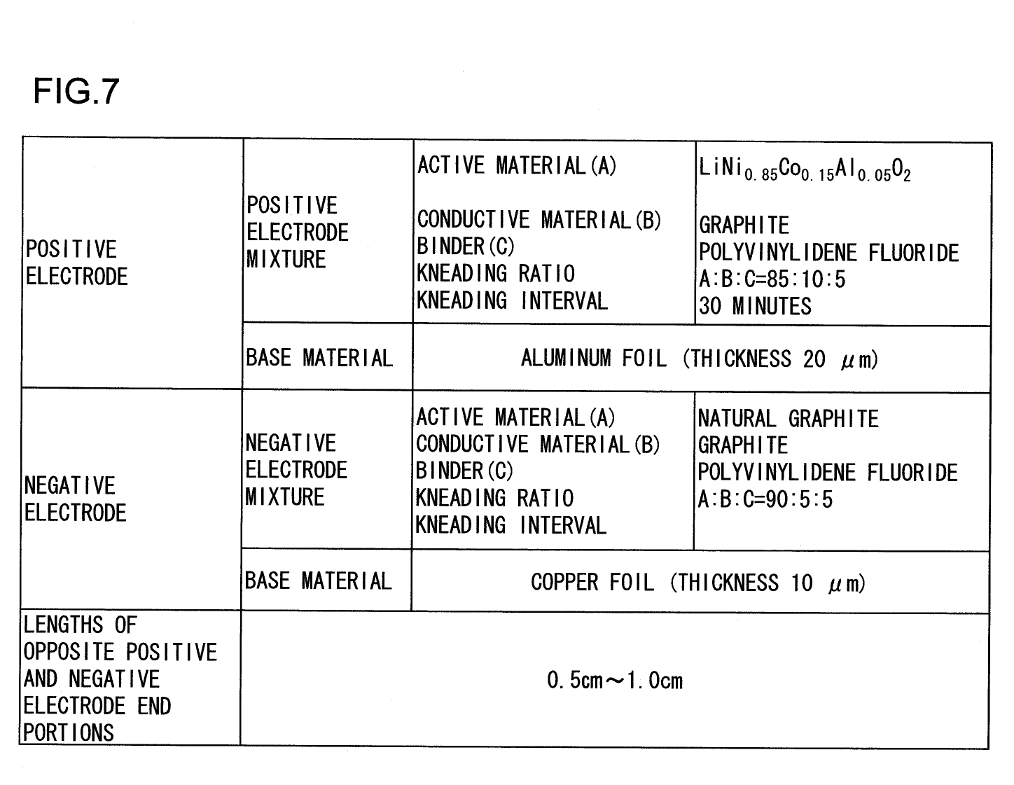

Lithium ion secondary cells of Embodiments #7 and #8 as shown in FIGS. 9 through 12 were manufactured in a similar manner to the lithium ion secondary cells of Embodiments #1 through #4. It should be understood that, with the wound groups 20 of Embodiments #7 and #8, as shown in FIG. 7, LiNi_{0.85}Co_{0.15}Al_{0.05}O₂ is used as the positive electrode active material, and natural graphite is used as the negative electrode active material. Moreover, it should be understood that the capacity ratios of these cells (negative electrode capacity/positive electrode capacity) were 1.0 to 1.2.

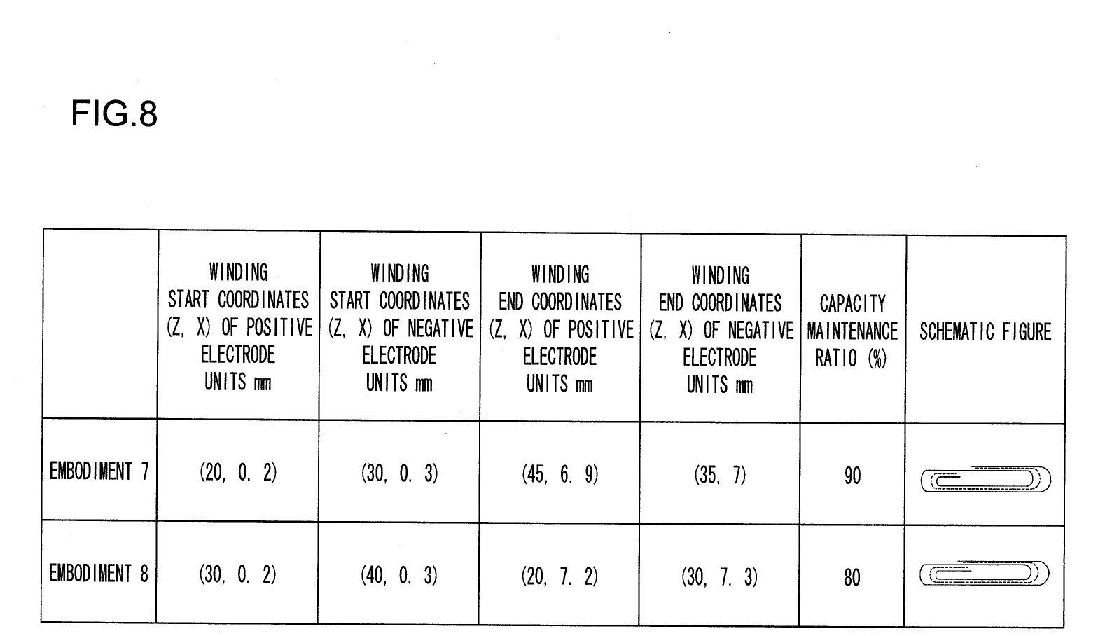

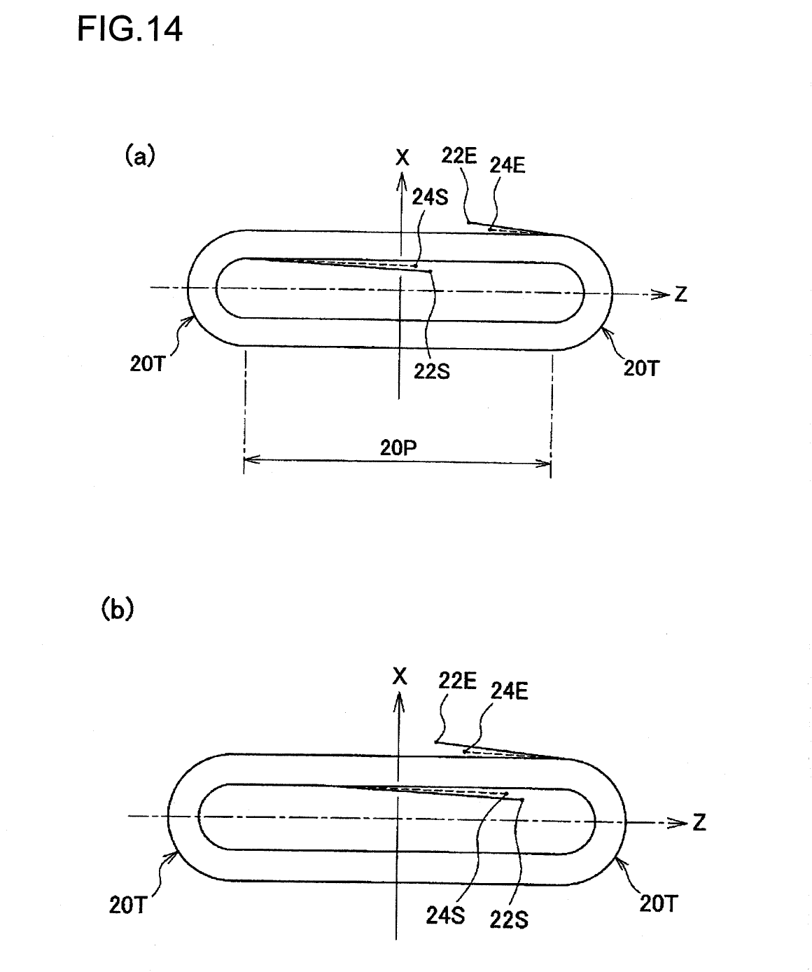

As shown in FIG. 8, no axial cores were used for producing these wound groups 20: they were manufactured by winding the separators around four times, and the winding start edges 24S and 22S and the winding ending edges 24E and 22E were set to the (Z,X) coordinates in the XYZ coordinate system shown in FIG. 14(a) in Embodiment #7, and to the (Z,X) coordinates in the XYZ coordinate system shown in FIG. 14(b) in Embodiment #8. In this case, the Z axis is the central axis of the wound group 20 in its thickness direction, while the X axis is the central axis of the wound group 20 in its lengthwise direction. The flat portion of the wound group 20 consists of an upper half flat portion and a lower half flat portion, and these are separated by the Z axis that is the central axis in the thickness direction.

With the lithium ion secondary cell of Embodiment #7 of FIG. 14(a), all of the winding starting edge 24S of the positive electrode 24 of the wound group 20, the winding starting edge 22S of its negative electrode 22, the winding ending edge 24E of the positive electrode 24, and the winding ending edge 22E of the negative electrode 22 are disposed within the region of the flat surface 20P. The winding starting edge 24S of the positive electrode 24 and the winding starting edge 22S of the negative electrode 22 are disposed on the innermost turn of the upper half flat portion, and the winding ending edge 24E of the positive electrode 24 and the winding ending edge 22E of the negative electrode 22 are disposed upon the outermost turn of the upper half flat portion. At the outermost turn of the upper half flat portion, the winding ending edge 24E of the positive electrode 24 is positioned on the flat surface 20P before arriving at the positions that correspond to the winding starting edge 24S of the positive electrode 24 and the winding starting edge 22S of the negative electrode 22. In other words, the portion of the positive electrode 24 at the start of winding from its final end at the innermost turn of the wound group 20 to the winding starting edge 24S of the positive electrode 24 is arranged so as to overlap neither the winding end side portion of the positive electrode 24 from the final end of the outermost turn of the wound group 20 to the winding end portion 24E of the positive electrode 24, nor the winding end side portion of the negative electrode from the final end of the outermost turn of the wound group 20 to the winding end portion 22E of the negative electrode 22.

Moreover, on the outermost turn of the upper half flat portion, the winding ending edge 22E of the negative electrode 22 is positioned upon the flat surface 20P before arriving at the positions that correspond to the winding starting edge 24S of the positive electrode 24 and to the winding starting edge 22S of the negative electrode 22. In other words, the portion of the negative electrode 22 at the start of winding from the final end at the innermost turn of the wound group 20 to the winding starting edge 22S of the negative electrode 22 is also arranged so as to overlap neither the winding end side portion of the positive electrode 24 from the final end of the outermost turn of the wound group 20 to the winding end portion 24E of the positive electrode 24, nor the winding end side portion of the negative electrode from the final end of the outermost turn of the wound group 20 to the winding end portion 22E of the negative electrode 22.

To put it in another manner, both the portion of the positive electrode 24 on the outermost turn and the portion of the negative electrode 22 on the outermost turn at the upper half flat portion have respective regions that do not overlap the portion of the positive electrode 24 on the innermost turn and the portion of the negative electrode 22 on the innermost turn at the upper half flat portion.

And, with the lithium ion secondary cell of Embodiment #8 of FIG. 14(b) as well, all of the winding starting edge 24S of the positive electrode 24 of the wound group 20, the winding starting edge 22S of its negative electrode 22, the winding ending edge 24E of the positive electrode 24, and the winding ending edge 22E of the negative electrode 22 are disposed within the region of the flat surface 20P. The winding starting edge 24S of the positive electrode 24 and the winding starting edge 22S of the negative electrode 22 are disposed on the innermost turn of the upper half flat portion, and the winding ending edge 24E of the positive electrode 24 and the winding ending edge 22E of the negative electrode 22 are disposed upon the outermost turn of the upper half flat portion. These features are the same as for the lithium ion secondary cell of Embodiment #7 of FIG. 14(a).

However, with the lithium ion secondary cell of Embodiment #8 of FIG. 14(b), on the outermost circumferential surface of the upper half flat portion, the winding ending edge 24E of the positive electrode 24 is arranged at a position upon the flat surface 20P that is past the positions that correspond to the winding starting edge 24S of the positive electrode 24 and the winding starting edge 22S of the negative electrode 22. In other words, the portion of the positive electrode 24 at the start of winding from the final end at the innermost turn of the wound group 20 to the winding starting edge 24S of the positive electrode 24 is arranged so as to overlap both the winding end side portion of the positive electrode 24 from the final end of the outermost turn of the wound group 20 to the winding end portion 24E of the positive electrode 24, and also a part of the winding end side portion of the negative electrode from the final end of the outermost turn of the wound group 20 to the winding end portion 22E of the negative electrode 22.

Moreover, on the outermost turn of the upper half flat portion, the winding ending edge 22E of the negative electrode 22 is arranged at a position upon the flat surface 20P that is past the positions that correspond to the winding starting edge 24S of the positive electrode 24 and the winding starting edge 22S of the negative electrode 22. In other words, the portion of the negative electrode 22 at the start of winding from the final end at the innermost turn of the wound group 20 to the winding starting edge 22S of the negative electrode 22 is also arranged so as to overlap both a portion of the winding end side portion of the positive electrode 24 from the final end of the outermost turn of the wound group 20 to the winding end portion 24E of the positive electrode 24, and also a part of the winding end side portion of the negative electrode from the final end of the outermost turn of the wound group 20 to the winding end portion 22E of the negative electrode 22.

To put it in another manner, both the winding start side end portion of the positive electrode 24 on the outermost turn and also the winding start side end portion of the negative electrode 22 on the outermost turn at the upper half flat portion are overlapped over the winding end side end portion of the positive electrode 24 on the innermost turn and the winding end side end portion of the negative electrode 22 on the innermost turn. Due to this, the lithium ion secondary cell of Embodiment #8 of FIG. 14(b) is thicker than the lithium ion secondary cell of Embodiment #7 of FIG. 14(a), just at the portion where the end portions of the wound group 20 at the start of winding at the innermost turn overlap its end portions at the end of winding at the outermost turn.

The thicknesses of the positive electrode 24, the negative electrode 22, and the separator 21 were respectively made to be 100 μm, 100 μm, and 40 μm. It should be understood that, in FIG. 8, the units for the Z and X coordinates are mm. For example, (20,0.2) denotes a position that is 20 mm in the Z coordinate (the length direction) and 0.2 mm in the X coordinate (the thickness direction).

With Embodiments #7 and #8 shown in FIG. 8,the X coordinates of the winding starting edge 24S of the positive electrode 24 and of the winding start edge 22S of the negative electrode 22 are the same. On the other hand, the X coordinates of the winding ending edge 24E of the positive electrode 24 and of the winding ending edge 22E of the negative electrode 22 are both 0.3 mm larger in Embodiment #8 than in Embodiment #7. Thus, since the X coordinates are the thicknesses of the wound groups 20, Embodiment #8 is 0.3 mm thicker as compared to Embodiment #7. In other words, in Embodiment #8, the thickness is somewhat increased by three layers of the separator 21, one layer of the positive electrode 24, and one layer of the negative electrode 22. To calculate the amount of increase of the thickness in more detail, since the increase in thickness of the separator 21 is 40 μm×3=120 μm and the increase in thickness of the positive electrode 24 and the negative electrode 22 is 100 μm×2=200 μm, the total difference in thickness is 320 μm.

Charging and discharging of the lithium ion secondary cells of Embodiments #7 and #8 was performed through three cycles in which the final voltage after charging was completed was 4.1 V, the final voltage at the end of discharging was 2.7 V, and the charge and discharge rates were 1 C (i.e. at one hour rate of their nominal electrical capacity), and the cells were then charged and discharged at 60° C. through 1000 cycles in which the final voltage after charging was completed was 4.1 V, the final voltage at the end of discharging was 2.7 V, and the charge and discharge rates were 10 CA (i.e. at 1/10 hour rate of their nominal electrical capacity).

As a result, as shown in FIG. 8, while the capacity maintenance ratio of Embodiment #7 was around 90%, that of Embodiment #8 was around 80%. This is considered that, because the distance between the electrodes became shorter due to the thickened portion of the wound group 20 being stuffed into the cell casing, so that a portion whose resistance was low was created at one portion, the electrical current was concentrated in this portion so that deterioration was promoted.

By comparison between Embodiment #7 and Embodiment #8 it will be understood that, for a wound group 20 in which the flat surface 20P is cut into two halves along the winding direction, it is desirable for the winding starting edge 22S and the winding ending edge 22E of the negative electrode 22 to be set on the same surface (Z,X) or the same surface (−Z, X), and moreover that it is desirable for the absolute values of the X coordinates and the Z coordinates of the winding ending edges 24E and 22E to be set to be larger than the respective absolute values of the X coordinates and the Z coordinates of the winding starting edges 24S and 22S. By determining the positions of the winding starting edges and the winding ending edges in this manner, it is possible to make the thickness of the wound group 20 and the distance between its electrodes uniform so that it is possible to suppress the deposition of lithium dendrites.

With the lithium ion secondary cells of Embodiments #7 and #8, in addition to similar beneficial effects to those of Embodiments #1 through #4, the further beneficial effect is obtained that the thickness of the wound group 20 and the distance between the positive electrode 24 and the negative electrode 22 are made uniform.

As has been explained above, the lithium ion secondary cell according to the present invention is provided with the wound group, in which the sheet shaped positive electrode and the sheet shaped negative electrode are wound into a flattened shape with the interposition of the separators. This wound group is accommodated in the cell casing while being immersed in electrolytes of various types, and moreover while being insulated. The external positive terminal that is connected to the sheet shaped positive electrode and the external negative terminal that is connected to the sheet shaped negative electrode are provided to the cell casing, and discharging and charging are performed via these external terminals. With the wound group of the present invention, the winding starting edges and the winding ending edges of the positive electrode and the negative electrode are not positioned on the circular arc portions at both ends of the wound group, but are positioned towards the central flattened portion. Moreover, the winding starting edge of the negative electrode is disposed more towards the inner peripheral side of the wound group than the winding starting edge of the positive electrode, while the winding ending edge of the negative electrode is disposed more towards the outer peripheral side of the wound group than the winding ending edge of the positive electrode. Furthermore, in the embodiments, by prescribing the length of the negative electrode and the positive electrode in the longitudinal direction, the negative electrode mixture layer is disposed so as to oppose all of the positive electrode mixture layer with the interposition of the separators. To put this in another manner, in the wound group of the lithium ion secondary cell according to the present invention, the positive electrode is covered by the negative electrode.

It should be understood that, in the embodiments described above, a construction has been adopted in which the winding starting edge of the positive electrode 24 and the winding starting edge of the negative electrode 22 are disposed at the inner peripheral side of the upper half flat portion, and the winding ending edge of the positive electrode 24 and the winding ending edge of the negative electrode 22 are disposed at the outer peripheral side of the upper half flat portion. However, it would also be acceptable to adopt a construction in which the winding starting edge of the positive electrode 24 and the winding starting edge 22S of the negative electrode 22 are disposed at the inner peripheral side of the lower half flat portion. Moreover, it would also be acceptable to adopt a construction in which the winding starting edge 24S of the positive electrode 24 and the starting edge portion 22S of the negative electrode 22 are disposed at the inner peripheral side of the upper half flat portion, and the winding ending edge 24E of the positive electrode 24 and the winding ending edge 22E of the negative electrode 22 are disposed at the outer peripheral side of the lower half flat portion. Conversely, it would also be acceptable to adopt a construction in which the winding starting edge 24S of the positive electrode 24 and the starting edge portion 22S of the negative electrode 22 are disposed at the inner peripheral side of the lower half flat portion, and the winding ending edge 24E of the positive electrode 24 and the winding ending edge 22E of the negative electrode 22 are disposed at the outer peripheral side of the upper half flat portion.

In the embodiments described above, the construction was such that the winding start side end portion of the negative electrode 22 at the innermost turn of the wound group 20 was disposed so as not to overlap the winding end side end portions of the positive electrode 24 and the negative electrode 22 on the outermost turn. However, although the winding start side end portion of the negative electrode 22 at the innermost turn of the wound group 20 does not overlap the winding end side end portion of the positive electrode 24 at the outermost turn, it would be acceptable to arrange for a portion thereof to be disposed so as to overlap a portion of the negative electrode 22 at the outermost turn.

The lithium ion secondary cell according to the present invention is not limited to the embodiments described above; it would also be possible to apply the present invention to lithium ion secondary cells that use any materials of the following types.

A lithium transition metal oxide may be used for the positive electrode active material. It is also possible to replace a portion of the Ni, the Co or the like of the positive electrode active material such as lithium nickel oxide, lithium oxide, or the like with one or more types of transition metal.

Any substance that can occlude and emit Li, such as natural graphite, synthetic graphite, hard graphitized carbon, graphitizable carbon, silicon, or the like may be used for the negative electrode active material. While in general, in addition to the active material, a binder and a conductive material and so on are included in the positive electrode mixture and the negative electrode mixture, in these embodiments the types and amounts of such substances are not particularly limited.

As the electrolyte, for example, it is possible to use an already known electrolyte that is employed in cells, such as an organic electrolyte in which at least one or more lithium salt selected from, for example, LiPF6, LiBF4, LiClO4, LiN(C2F5SO2)2 or the like is dissolved in a non-aqueous solvent selected from at least one or more of ethylene carbonate, propylene carbonate, butylene carbonate, dimethyl carbonate, ethyl methyl carbonate, diethyl carbonate, γ-butyrolactone, γ-valerolactone, methyl acetate, ethyl acetate, methyl-propionate, tetra-hydro-furan, 2-methyl-tetra-hydro-furan, 1,2-dimethoxyethane, 1-ethoxy-2-methoxy-ethane, 3-methyl-tetra-hydro-furan, 1,2-dioxane, 1,3-dioxane, 1,4-dioxane, 1,3-dioxolane, 2-methyl-1,3-dioxolane, 4-methyl-1,3-dioxolane or the like, or a solid electrolyte or a gel type electrolyte or a molten salt or the like that have conductivity of lithium ion.

Moreover, for the separators, it is possible to use separators of common polyethylene, polypropylene or the like, or separators containing an inorganic material such as alumina, silica, or the like, or ones to which such an inorganic material has been applied. Furthermore, for the wound group of the lithium ion secondary cell according to the present invention, any structure having a flat surface and circular arcuate surfaces may be employed, and it is not important whether or not a winding former is present. Yet further, apart from automotive applications, the lithium ion secondary cell of the present invention may be used in various types of manufactured product, such as a UPS power supply or a portable telephone or the like.

Apart from the above, within the range of the gist of the present invention, the lithium ion secondary cell of the present invention can be applied in various altered ways; the point is that it should include a wound group, in which a sheet shaped positive electrode including a positive electrode mixture layer and a sheet shaped negative electrode including a negative electrode mixture layer are wound together with the interposition of a separator, and formed into a flattened shape configured to include a flat portion and circular arc shaped portions joined at opposite edges of the flat portion, and a cell casing in which the wound group is accommodated in the state of being immersed in an electrolyte, and that includes an external positive terminal that is connected to the sheet shaped positive electrode and an exterior negative terminal that is connected to the sheet shaped negative electrode; with: a winding starting edge of the negative electrode being disposed more towards the inner peripheral side of the wound group than a winding starting edge of the positive electrode; a winding ending edge of the negative electrode being disposed more towards the outer peripheral side of the wound group than a winding ending edge of the positive electrode; a winding starting edge of the positive electrode, the winding starting edge of the negative electrode, a winding ending edge of the positive electrode, and the winding ending edge of the negative electrode not being disposed within the circular arc portions of the wound group, but being disposed within the region of the flat portion of the wound group; and the negative electrode mixture layer entirely covering a surface of the positive electrode layer being disposed over the inner circumferential surface and the outer circumferential surface of the positive electrode mixture layer.

Furthermore, the lithium ion secondary cell of the present invention may include a wound group formed by winding a layered sheet to assume a substantially circular arcuate shape while the layered sheet is repeatedly turned back at each opposite end of the circular arcuate shape and in which two upper and lower surfaces facing the two outer surfaces are flat surfaces at a central portion, the layered sheet being constituted by laminating a sheet shaped positive electrode in which the positive electrode mixture layer provided from a winding starting edge to a winding ending edge is spread on both sides of a metallic collector, a sheet shaped negative electrode in which a negative electrode mixture layer provided from the winding starting edge to the winding ending edge is spread on both sides of a metallic collector, and a sheet shaped separator interposed between the positive electrode and the negative electrode, wherein: the winding starting edge of the negative electrode is disposed more to the inner peripheral side of the wound group than the winding starting edge of the positive electrode; the winding ending edge of the negative electrode is disposed more to the outer peripheral side of the wound group than the winding ending edge of the positive electrode; the winding starting edge of the positive electrode, the winding starting edge of the negative electrode, the winding ending edge of the positive electrode, and the winding ending edge of the negative electrode are disposed at positions that correspond to the flat surface; and the winding starting edge of the negative electrode is disposed more towards the winding center of the wound group than the winding starting edge of the positive electrode.

The content of the disclosure of the following application, upon that priority is claimed, is hereby incorporated herein by reference:

Japanese Patent Application 2009-223,152.

1. A lithium ion secondary cell, comprising:
a wound group, in which a sheet shaped positive electrode comprising a positive electrode mixture layer and a sheet shaped negative electrode comprising a negative electrode mixture layer are wound together with the interposition of a separator, and that is formed into a flattened shape configured to include a flat portion and circular arc shaped portions joined at opposite edges of the flat portion; and
a cell casing in which the wound group is accommodated in a state of being immersed in an electrolyte, and that includes an external positive terminal that is connected to the sheet shaped positive electrode and an exterior negative terminal that is connected to the sheet shaped negative electrode; and wherein:
a winding starting edge of the negative electrode is disposed more towards an inner peripheral side of the wound group than a winding starting edge of the positive electrode;
a winding ending edge of the negative electrode is disposed more towards an outer peripheral side of the wound group than a winding ending edge of the positive electrode;
the winding starting edge of the positive electrode, the winding starting edge of the negative electrode, the winding ending edge of the positive electrode, and the winding ending edge of the negative electrode are disposed within a region of the flat portion of the wound group not so as to be disposed within a region of the circular arc portions of the wound group; and
the negative electrode mixture layer entirely covering a surface of the positive electrode mixture layer is disposed on an inner circumferential surface and an outer circumferential surface of the positive electrode mixture layer.

2. A lithium ion secondary cell according to claim 1, wherein
the winding starting edge of the positive electrode and the winding ending edge of the positive electrode are disposed so as not to be mutually overlapped in a direction from a front to a back of the flat portion, and the winding starting edge of the negative electrode and the winding ending edge of the negative electrode are disposed so as not to be mutually overlapped in the direction from the front to the back of the flat portion.

3. A lithium ion secondary cell according to claim 1, wherein:
the flat portion of the wound group has an upper half flat portion and a lower half flat portion separated by a boundary at a central axis in a thickness direction; the winding starting edge of the positive electrode and the winding starting edge of the negative electrode are disposed at the inner peripheral side of one of the upper half flat portion and the lower half flat portion; and the winding ending edge of the positive electrode and the winding ending edge of the negative electrode are disposed at the outer peripheral side of the one of the upper half flat portion and the lower half flat portion at which the winding starting edge of the positive and the winding starting edge of the negative electrode are disposed.

4. A lithium ion secondary cell according to claim 1, wherein
a winding start side portion of the positive electrode at an innermost turn of the wound group is disposed so as not to overlap a winding end side portion of the negative electrode at an outermost turn, and a winding start side portion of the negative electrode at the innermost turn of the wound group is disposed so as not to overlap a winding side end portion of the negative electrode at the outermost turn.

5. A lithium ion secondary cell according to claim 3, wherein
a winding start side portion of the positive electrode at an innermost turn of the wound group is disposed so as not to overlap a winding end side portion of the positive electrode at an outermost turn and a winding end side portion of the negative electrode at the outermost turn, and a winding start side portion of the negative electrode at the innermost turn of the wound group is disposed so as not to overlap the winding end side portion of the positive electrode at the outermost turn and the winding end side portion of the negative electrode at the outermost turn.

6. A lithium ion secondary cell comprising:
a wound group formed by winding a layered sheet to assume a substantially circular arcuate shape while the layered sheet is repeatedly turned back at each opposite end of the circular arcuate shape and in which two upper and lower outer surfaces and two inner surfaces facing the two outer surfaces are flat surfaces at a central portion, the layered sheet being constituted by laminating a sheet shaped positive electrode in which a positive electrode mixture layer provided from a winding starting edge to a winding ending edge is spread on both sides of a metallic collector, a sheet shaped negative electrode in which a negative electrode mixture layer provided from the winding starting edge to the winding ending edge is spread on both sides of a metallic collector, and a sheet shaped separator is interposed between the positive electrode and the negative electrode, wherein:
the winding starting edge of the negative electrode is disposed more to an inner peripheral side of the wound group than the winding starting edge of the positive electrode;
the winding ending edge of the negative electrode is disposed more to an outer peripheral side of the wound group than the winding ending edge of the positive electrode;
the winding starting edge of the positive electrode, the winding starting edge of the negative electrode, the winding ending edge of the positive electrode, and the winding ending edge of the negative electrode are disposed at positions that correspond to the flat surface; and
the winding starting edge of the negative electrode is disposed more towards the winding center of the wound group than the winding starting edge of the positive electrode.

7. A lithium ion secondary cell according to claim 6, wherein the negative electrode mixture layer entirely covering a surface of the positive electrode mixture layer is disposed on an inner circumferential surface and an outer circumferential surface of the positive electrode mixture layer.

8. A lithium ion secondary cell according to claim 6, wherein
the winding starting edge of the positive electrode and the winding ending edge of the positive electrode are disposed so as not mutually to overlap in a direction from a front to a back of the central portion, and the winding starting edge of the negative electrode and the winding ending edge of the negative electrode are disposed so as not mutually to overlap in the direction from the front to the back of the central portion.

9. A lithium ion secondary cell according to claim 6, wherein
the winding starting edge of the positive electrode, the winding starting edge of the negative electrode, the winding ending edge of the positive electrode, and the winding ending edge of the negative electrode are disposed upon one of the inner surfaces of the central portion of the wound group, and upon the outer surface that opposes that one of the inner surfaces.

10. A lithium ion secondary cell according to claim 6, wherein
a winding start side portion of the positive electrode at an innermost turn of the wound group is disposed so as not to overlap a winding end side portion of the negative electrode at an outermost turn thereof, and a winding start side portion of the negative electrode at the innermost turn of the wound group is disposed so as not to overlap a winding end side portion of the negative electrode at the outermost turn thereof.

11. A lithium ion secondary cell according to claim 6, wherein
a winding start side portion of the positive electrode at an innermost turn of the wound group is disposed so as not to overlap a winding end side portion of the positive electrode at an outermost turn thereof and a winding end side portion of the negative electrode at the outermost turn thereof, and a winding start side portion of the negative electrode at an innermost turn of the wound group is disposed so as not to overlap the winding end side portion of the positive electrode at the outermost turn thereof and the winding end side portion of the negative electrode at the outermost turn thereof.

12. A lithium ion secondary cell according to claim 4, wherein
a winding start side portion of the positive electrode at an innermost turn of the wound group is disposed so as not to overlap a winding end side portion of the positive electrode at an outermost turn and a winding end side portion of the negative electrode at the outermost turn, and a winding start side portion of the negative electrode at the innermost turn of the wound group is disposed so as not to overlap the winding end side portion of the positive electrode at the outermost turn and the winding end side portion of the negative electrode at the outermost turn.
